(19) United States
(12) Patent Application Publication
(10) Pub. No.: US 2008/0298246 A1
(43) Pub. Date: Dec. 4, 2008

(54) Multiple Link Traffic Distribution

(76) Inventors: William A. Hughes, San Jose, CA (US); Chen-Ping Yang, Fremont, CA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/756,984

(22) Filed: Jun. 1, 2007

(51) Int. Cl. H04L 12/56; H04L 12/24

(52) U.S. Cl. 370/236; 370/422

(57) ABSTRACT

In one embodiment, a node comprises a plurality of interface circuits coupled to a node controller. Each of the plurality of interface circuits is configured to couple to a respective link of a plurality of links. The node controller is configured to select a first link from two or more of the plurality of links to transmit a first packet, wherein the first link is selected responsive to a relative amount of traffic transmitted via each of the two or more of the plurality of links.

### BACKGROUND

1. Field of the Invention

This invention is related to the field of packet communications in electronic systems such as computer systems, and to routing packet traffic in such systems.

2. Description of the Related Art

Systems that implement packet communications (as opposed to shared bus communications) often implement point-to-point interconnect between nodes in the system. For convenience, a link between nodes will be referred to herein. Each link is one communication path between nodes, and a packet can be transmitted on the link. The link can be one way or two way.

In a multinode system, each node typically includes circuitry to interface to Is multiple other nodes. For example, 3 or 4 links can be supported from a given node to connect to other nodes. However, if fewer than the maximum number of nodes is included in a given system, then links on a particular node can be idle. Bandwidth that could otherwise be used to communicate in the system is wasted.

One packet-based link interconnect is specified in the HyperTransport™ (HT) specification for I/O interconnect. A corresponding coherent HT (cHT) specification also exists. Packets on HT and cHT travel in different virtual channels to provide deadlock free operation. Specifically, posted request, non-posted request, and response virtual channels are provided on HT, and cHT includes those virtual channels and the probe virtual channel. Routing of packets can be based on virtual channel according to the HT specification, and thus different packets to the same node but in different virtual channels can be routed on different links. If those links are all coupled to the same other node, some of the wasted bandwidth can be reclaimed.

Unfortunately, the use of multiple links for different virtual channels does not lead to even use of bandwidth on the links. Responses are more frequent than requests (e.g. several occur per coherent request). Frequently, responses include data since the responses to read requests (the most frequent requests) carry the data. For block-sized responses, the data is significant larger than the non-data carrying responses, requests, and probes. Additionally, the packets transmitted in a given virtual channel may be bursty, and thus bandwidth on other links goes unused while the bursty channel travels over one link.

### SUMMARY

In one embodiment, a node comprises a plurality of interface circuits coupled to a node controller. Each of the plurality of interface circuits is configured to couple to a respective link of a plurality of links. The node controller is configured to select a first link from two or more of the plurality of links to transmit a first packet, wherein the first link is selected responsive to a relative amount of traffic transmitted via each of the two or more of the plurality of links. A system comprising two or more of the nodes is also contemplated.

In an embodiment, a method comprises receiving a first packet in a node controller within a node that is configured to couple to a plurality of links; and selecting a link from two or more of the plurality of links to transmit the first packet, wherein the selecting is responsive to a relative amount of traffic transmitted via each of the two or more of the plurality of links.

In another embodiment, a node comprises a plurality of interface circuits coupled to a node controller. Each of the plurality of interface circuits is configured to couple to a respective link of a plurality of links. The node controller comprises a routing table programmed to select among the plurality of links to transmit each packet of a plurality of packets, wherein the routing table is programmed to select among the plurality of links responsive to one or more packet attributes of each packet. The node controller is further configured to select a first link from two or more of the plurality of links for at least a first packet of the plurality of packets. The node controller is configured to transmit the first packet using the first link instead of a second link indicated by the routing table for the first packet.

### BRIEF DESCRIPTION OF THE DRAWINGS

The following detailed description makes reference to the accompanying drawings, which are now briefly described.

FIG. 1 is a block diagram of one embodiment of a system.

FIG. 2 is a block diagram of another embodiment of a system.

FIG. 3 is a block diagram of one embodiment of a multi-chip module.

FIG. 4 is a block diagram of one embodiment of a node shown in FIGS. 1-3.

FIG. 5 is a block diagram of one embodiment of a control register shown in FIG. 4.

FIG. 6 is a flowchart illustrating operation of one embodiment of a node controller in FIG. 4.

FIG. 7 is a block diagram of another embodiment of a node shown in FIGS. 1-3.

FIG. 8 is a block diagram of one embodiment of a control register shown in FIG. 7.

FIG. 9 is a flowchart illustrating operation of one embodiment of a node controller in FIG. 7 to write a queue entry.

FIG. 10 is a flowchart illustrating operation of one embodiment of a node controller in FIG. 7 schedule a packet corresponding to a queue entry.

FIG. 11 is a flowchart illustrating one embodiment of distributing traffic over multiple links.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

### Overview

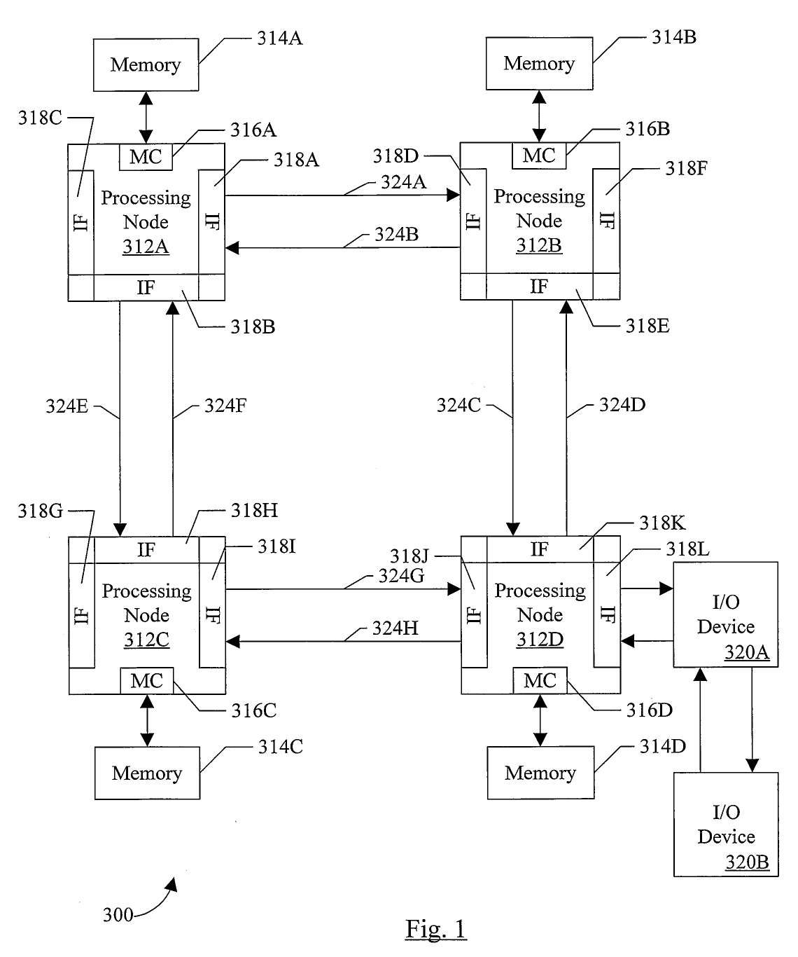

Turning now to FIG. 1, an embodiment of a computer system 300 is shown. In the embodiment of FIG. 1, computer system 300 includes several processing nodes 312A, 312B, 312C, and 312D. Each processing node is coupled to a respective memory 314A-314D via a memory controller 316A-316D included within each respective processing node 312A-312D. Additionally, processing nodes 312A-312D include an interface circuit to communicate between the processing nodes 312A-312D. For example, processing node 312A includes interface circuit 318A for communicating with processing node 312B, interface circuit 318B for communicating with processing node 312C, and interface circuit 318C for communicating with yet another processing node (not shown). Similarly, processing node 312B includes interface circuits 318D, 318E, and 318F; processing node 312C includes interface circuits 318G, 318H, and 318I; and processing node 312D includes interface circuits 318J, 318K, and 318L. Processing node 312D is coupled to communicate with a plurality of input/output devices (e.g. devices 320A-320B in a daisy chain configuration) via interface circuit 318L. Other processing nodes may communicate with other I/O devices in a similar fashion.

Processing nodes 312A-312D implement a packet-based interface for inter-processing node communication. In the present embodiment, the interface is implemented as sets of unidirectional links (e.g. links 324A are used to transmit packets from processing node 312A to processing node 312B and links 324B are used to transmit packets from processing node 312B to processing node 312A). Other sets of links 324C-324H are used to transmit packets between other processing nodes as illustrated in FIG. 1. Generally, each set of links 324 may include one or more data lines, one or more clock lines corresponding to the data lines, and one or more control lines indicating the type of packet being conveyed. The link may be operated in a cache coherent fashion for communication between processing nodes or in a noncoherent fashion for communication between a processing node and an I/O device (or a bus bridge to an I/O bus of conventional construction such as the Peripheral Component Interconnect (PCI) bus or Industry Standard Architecture (ISA) bus). Furthermore, the link may be operated in a non-coherent fashion using a daisy-chain structure between I/O devices as shown. It is noted that a packet to be transmitted from one processing node to another may pass through one or more intermediate nodes. For example, a packet transmitted by processing node 312A to processing node 312D may pass through either processing node 312B or processing node 312C as shown in FIG. 1. Any suitable routing algorithm may be used. Other embodiments of computer system 300 may include more or fewer processing nodes then the embodiment shown in FIG. 1.

Generally, the packets may be transmitted as one or more bit times on the links 324 between nodes. A given bit time may be referenced to the rising or falling edge of the clock signal on the corresponding clock lines. That is, both the rising and the falling edges may be used to transfer data, so that the data rate is double the clock frequency (double data rate, or DDR). The packets may include request packets for initiating transactions, probe packets for maintaining cache coherency, and response packets for responding to probes and requests (and for indicating completion by the source/target of a transaction). Some packets may indicate data movement, and the data being moved may be included in the data movement packets. For example, write requests include data. Probe responses with modified data and read responses both include data. Thus, in general, a packet may include a command portion defining the packet, its source and destination, etc. A packet may optionally include a data portion following the command portion. The data may be a cache block in size, for coherent cacheable operations, or may be smaller (e.g. for non-cacheable reads/writes). A block may be the unit of data for which coherence is maintained. That is, the block of data is treated as a unit for coherence purposed. Coherence state is maintained for the unit as a whole (and thus, if a byte is written in the block, then the entire block is considered modified, for example). A block may be a cache block, which is the unit of allocation or deallocation in the caches, or may differ in size from a cache block.

Processing nodes 312A-312D, in addition to a memory controller and interface logic, may include one or more processors. Broadly speaking, a processing node comprises at least one processor and may optionally include a memory controller for communicating with a memory and other logic as desired. One or more processors may comprise a chip multiprocessing (CMP) or chip multithreaded (CMT) integrated circuit in the processing node or forming the processing node, or the processing node may have any other desired internal structure. Any level of integration or any number of discrete components may form a node. Other types of nodes may include any desired circuitry and the circuitry for communicating on the links. For example, the I/O devices 320A-320B may be I/O nodes, in one embodiment. Generally, a node may be treated as a unit for coherence purposes. Thus, the coherence state in the coherence scheme may be maintained on a per-node basis. Within the node, the location of a given coherent copy of the block may be maintained in any desired fashion, and there may be more than one copy of the block (e.g. in multiple cache levels within the node).

Memories 314A-314D may comprise any suitable memory devices. For example, a memory 314A-314D may comprise one or more RAMBUS DRAMs (RDRAMs), synchronous DRAMs (SDRAMs), DDR SDRAM, static RAM, etc. The address space of computer system 300 is divided among memories 314A-314D. Each processing node 312A-312D may include a memory map used to determine which addresses are mapped to which memories 314A-314D, and hence to which processing node 312A-312D a memory request for a particular address should be routed. In one embodiment, the coherency point for an address within computer system 300 is the memory controller 316A-316D coupled to the memory storing bytes corresponding to the address. In other words, the memory controller 316A-316D is responsible for ensuring that each memory access to the corresponding memory 314A-314D occurs in a cache coherent fashion. Memory controllers 316A-316D may comprise control circuitry for interfacing to memories 314A-314D. Additionally, memory controllers 316A-316D may include request queues for queuing memory requests.

Generally, interface circuits 318A-318L may comprise a variety of buffers for receiving packets from the link and for buffering packets to be transmitted upon the link. Computer system 300 may employ any suitable flow control mechanism for transmitting packets. For example, in one embodiment, each interface circuit 318 stores a count of the number of each type of buffer within the receiver at the other end of the link to which that interface logic is connected. The interface logic does not transmit a packet unless the receiving interface logic has a free buffer to store the packet. As a receiving buffer is freed by routing a packet onward, the receiving interface logic transmits a message to the sending interface logic to indicate that the buffer has been freed. Such a mechanism may be referred to as a “coupon-based” system.

I/O devices 320A-320B may be any suitable I/O devices. For example, I/O devices 320A-320B may include devices for communicating with another computer system to which the devices may be coupled (e.g. network interface cards or modems). Furthermore, I/O devices 320A-320B may include video accelerators, audio cards, hard or floppy disk drives or drive controllers, SCSI (Small Computer Systems Interface) adapters and telephony cards, sound cards, and a variety of data acquisition cards such as GPIB or field bus interface cards. Furthermore, any I/O device implemented as a card may also be implemented as circuitry on the main circuit board of the system 300 and/or software executed on a processing node. It is noted that the term “I/O device” and the term “peripheral device” are intended to be synonymous herein.

In one embodiment, the links 324A-324H are compatible with the HyperTransport™ (HT) specification promulgated by the HT consortium, specifically version 3. The protocol on the links is modified from the HT specification to support coherency on the links, as described above. For the remainder of this discussion, HT links will be used as an example (and the interface circuits 318A-318L may be referred to as HT ports). However, other embodiments may implement any links and any protocol thereon. Additionally, processing nodes may be used as an example of nodes participating in the cache coherence scheme (coherent nodes). However, any coherent nodes may be used in other embodiments.

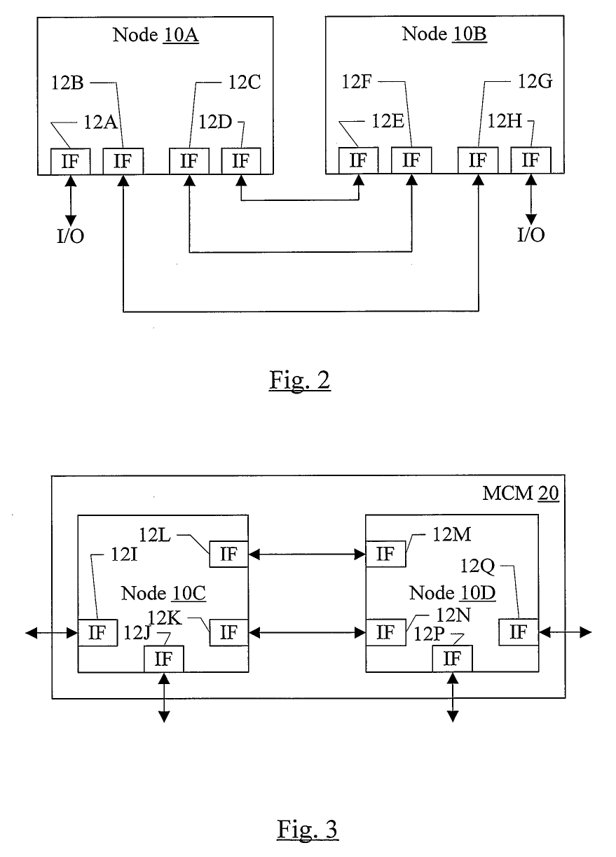

FIG. 1 illustrates several nodes 312A-312D in a system 300, and the relatively efficient use of the links in the system 300. Systems with fewer nodes would not necessarily utilize the links, unless multiple links are connect between the same two nodes. FIG. 2 is a block diagram illustrating one embodiment of a system including two nodes 10A-10B. Each node 10A-10B may be an instance of a processing node such as the processing nodes 312A-312B in FIG. 1, for example, or may be any other type of node. In FIG. 1, each node includes 4 interface circuits, 12A-12D in node 10A and 12E-12H in node 10B. Interface circuits 12A and 12H are coupled to links to I/O devices, and interface circuits 12B, 12C, and 12D are coupled to links to interface circuits 12G, 12F, and 12E, respectively, as shown in FIG. 2. Accordingly, three links worth of bandwidth is available between the nodes 10A-10B. The nodes 10A-10B may implement the packet distribution mechanism describe below to utilize the available bandwidth.

FIG. 3 illustrates one embodiment of a multi-chip module (MCM) 20 that includes two nodes 10C-10D. The nodes 10C-10D may be instances of a processing node such as the processing nodes 312A-312D, or may be other types of nodes. The nodes 10C-10D include four interface circuits 12I-12N and 12P-12Q, as shown. The MCM 20 includes 4 external links (e.g. so the MCM 20 can be directly inserted into a socket designed for a single node, such as the node 10A-10B in FIG. 2). The interface circuits 12I-12J and 12P-12Q may provide the external links. Thus interface circuits 12K-12N are available for communication between the nodes 10C-10D on the MCM 20. As shown, interface circuit 12L is coupled to a link to interface circuit 12M, and interface circuit 12K is coupled to a link to interface circuit 12N. In the case of the MCM 20, not only is the extra bandwidth of internal links between the nodes 10C-10D useful for communications between the nodes, but also for communications from one node that are to be routed off the MCM 20 through one of the interface circuits on the other node. It is noted that, in other embodiments, additional nodes may be included in the MCM 20. The number of external links and/or the number of interface circuits per node may vary in other embodiments.

### Packet Distribution

The nodes 10A-10D may implement a packet distribution mechanism to more evenly consume the available bandwidth on two or more links between the same two nodes. Each node may be configured to select a link (and thus an interface circuit that couples to that link) on which to transmit a packet. If the packet may be transmitted on one of two or more links, the node may select a link dependent on the relative amount of traffic that has been transmitted on each of the corresponding links. Traffic may be measured in any desired fashion (e.g. numbers of packets transmitted, number of bytes transmitted, or any other desired measurement). By incorporating the amount of traffic that has been transmitted on each eligible link, the nodes 10A-10D may be more likely to evenly use the available bandwidth on multiple links to the same other node (or close to evenly use the bandwidth). The packet distribution may be independent of virtual channel, packet type, etc. and thus any packets that are enabled for distribution may be distributed over the available links.

Each interface circuit is configured to couple to a different link. Accordingly, the selection of a “link” implies selecting an interface circuit to which the packet is routed. The interface circuit may drive the packet on the link, during use. For convenience, the discussion below may refer to selecting a link, which may be effectively synonymous with selecting an interface circuit that is coupled to that link during use.

In one embodiment, the nodes 10A-10D may implement a routing table that may use one or more packet attributes to identify the link on which the packet should be transmitted. Packet attributes may include any identifiable property or value related to the packet. For example, request packets may include an address of data to be accessed in the request. The address may be a packet attribute, and may be decoded to determine a link (e.g. a link that may result in the packet being routed to the home node for the address). For response packets, the source node may be a packet attribute. Other packet attributes may include virtual channel, destination node, etc. The packet attributes may be used to index the routing table and output a link identifier indicating a link on which the packet is to be routed. If packet distribution is implemented, the link selected according to the packet distribution mechanism may be used instead of the link identified by the routing table. The link identified by the routing table may be one of the links over which packet traffic is being distributed, and thus in some instances the output of the routing table and the packet distribution mechanism may be the same. Viewed in another way, two packets having the same packet attributes that are used to index the routing table 48 may be routed onto different links.

In one embodiment, the output of the routing table may be used for certain destination nodes and the packet distribution mechanism may be used for other destination nodes of packets. That is, nodes to which a given node is connected via two or more links may use the packet distribution mechanism and others may not. In another embodiment, certain links may be grouped together and the packet distribution mechanism may be used for those links.

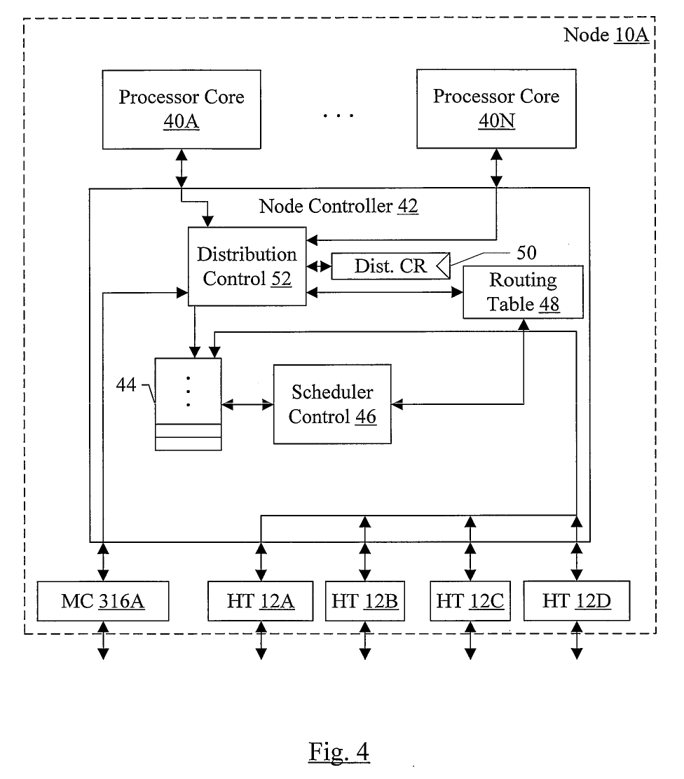

Turning now to FIG. 4, a block diagram of one embodiment of the node 10A is shown. Other nodes 10B-10C may be similar. Since the node 10A in FIG. 4 includes processor cores, the node 10A may be an instance of the node 312A, and other processing nodes 312B-312D may be similar. In the embodiment of FIG. 4, the node 10A includes one or more processor cores 40A-40N coupled to a node controller 42 which is further coupled to the interface circuits 12A-12D (HT ports 12A-12D in this embodiment) and the memory controller 316A. The node controller 42 may comprise a system request queue (SRQ) 44, a scheduler control unit 46, a routing table 48, a distribution control register 50, and a distribution control unit 52. The scheduler control unit 46 is coupled to the system request queue 44 and the routing table 48. The distribution control unit 52 is coupled to receive packets from the memory controller 316A and the processor cores 40A-40N, and is further coupled to the routing table 48, the distribution control register 50, and the SRQ 44. The SRQ 44 is further configured to receive packets from the HT ports 12A-12D. In one embodiment, the node 10A may be a single integrated circuit chip comprising the circuitry shown therein in FIG. 4. That is, the node 10A may be a chip multiprocessor (CMP). Other embodiments may implement the node 10A as two or more separate integrated circuits, as desired. Any level of integration or discrete components may be used.

The node controller 42 may generally be configured to receive packets from the processor cores 40A-40N, the memory controller 316A, and the HT ports 12A-12D and to route those communications to the processor cores 40A-40N, the HT ports 12A-12D, and the memory controller 316A dependent upon the packet type, the address in the packet, etc. The node controller 42 may write received packet-identifying data into the SRQ 44 (from any source). The node controller 42 (and more particularly the scheduler control unit 46) may schedule packets from the SRQ for routing to the destination or destinations among the processor cores 40A-40N, the HT ports 12A-12D, and the memory controller 316A. The processor cores 40A-40N and the memory controller 316A are local packet sources, which may generate new packets to be routed. The processor cores 40A-40N may generate requests, and may provide responses to received probes and other received packets. The memory controller 316A may generate responses for requests received by the memory controller 316A from either the HT ports 12A-12D or the processor cores 40A-40N, probes to maintain coherence, etc. The HT ports 12A-12D are external packet sources. Packets received from the HT ports 12A-12D may be passing through the node 10A (and thus may be routed out through another HT port 12A-12D) or may be targeted at a processor core 40A-40N and/or the memory controller 316A.

In this embodiment, the local packet sources may have an output link assigned by the distribution control unit 52 as the packets are input to the SRQ 44. The output link may be the link indicated by the routing table 48 for the packet (based on one or more packet attributes), or may be one of two or more links over which traffic is being distributed. In this embodiment, packet traffic may be distributed over two or more links for a particular destination node (or nodes) for locally generated packets from local packet sources. Packets from external sources may be routed based on the routing table output (e.g. as checked by the scheduler control unit 46). Distributing only locally generated packet traffic is one embodiment, other embodiments may distribute external packet traffic as well. Only distributing locally generated packet traffic may optimize for two node systems. However, other embodiments may implement traffic distribution for locally generated packets only in multinode systems as well.

For locally generated packets, the distribution control unit 52 may obtain a link assignment from the routing table 48 and may also check the destination node of the packet against the distribution control register 50. If the destination node matches a node listed in the distribution control register 50, the distribution control register 50 may also indicate which of the links are included in the subset of links over which packet traffic is being distributed. The distribution control unit 52 may select one of the links dependent on the relative amount of packet traffic that has been transmitted via each link in the subset. Various algorithms may be used for the selection. One is described in more detail with regard to FIG. 11, but any algorithm that takes into account relative amounts of traffic may be used. The distribution control unit 52 may provide the assigned link to the SRQ 44. It is noted that some locally generated packets may be targeted at another local packet source (e.g. a response from the memory controller 316A to the processor cores 40A-40N or a request from the processor cores 40A-40N targeting memory to which the memory controller 316A is connected). For those packets, there is no link to assign. Rather, the destination of the packet is the targeted internal packet source.

The routing table 48 may be programmable with link mappings (e.g. via instructions executed on a processor core 40A-40N or another processor core in another node). Similarly, the distribution control register 50 may be programmable with packet distribution control data. One or more distribution control registers 50 may be included in various embodiments. The routing table 48 and/or distribution control registers 50 may be programmed during system initialization, for example. In other embodiments, distribution control data may be provided by blowing fuses, tying pins, etc.

The distribution control unit 42 may be responsible for tracking packet traffic on the links that are identified in the distribution control data, to aid in the selection of a link on which the packet is transmitted. The distribution control unit 42 may update the traffic measurement data as packets are written to the SRQ 44 in this embodiment (or may update as the packets are transmitted to the interface circuits, in other embodiments).

Generally, the processor cores 40A-40N may use the interface to the node controller 42 to communicate with other components of the computer system. In one embodiment, communication on the interfaces between the node controller 42 and the processor cores 40A-40N may be in the form of packets similar to those used on the HT links. In other embodiments, any desired communication may be used (e.g. transactions on a bus interface, packets of a different form, etc.). Similarly, communication between the memory controller 316A and the node controller 42 may be in the form of HT packets.

When the scheduler control unit 46 has determined that a packet is ready to be scheduled, the scheduler control unit 46 may output data identifying the packet to packet buffers at the HT port 12A-12D, the memory controller 316A, and the processor cores 40A-40N. That is, the packets themselves may be stored at the source (or receiving interface circuit) and may be routed to the destination interface circuit/local source directly. Data used for scheduling may be written into the SRQ 44.

Generally, a processor core 40A-40N may comprise circuitry that is designed to execute instructions defined in a given instruction set architecture. That is, the processor core circuitry may be configured to fetch, decode, execute, and store results of the instructions defined in the instruction set architecture. The processor cores 40A-40N may comprise any desired configurations, including superpipelined, superscalar, or combinations thereof. Other configurations may include scalar, pipelined, non-pipelined, etc. Various embodiments may employ out of order speculative execution or in order execution. The processor core may include microcoding for one or more instructions or other functions, in combination with any of the above constructions. Various embodiments may implement a variety of other design features such as caches, translation lookaside buffers (TLBs), etc.

The routing table 48 may comprise any storage that can be indexed by packet attributes and store interface circuit identifiers. The routing table 48 may be a set of registers, a random access memory (RAM), a content addressable memory (CAM), combinations of the previous, etc.

While the embodiment of FIG. 4 illustrates a processing node, other types of nodes may be similar, and may include a node controller 42 as illustrated in FIG. 4, one or more local packet sources, and interface circuits.

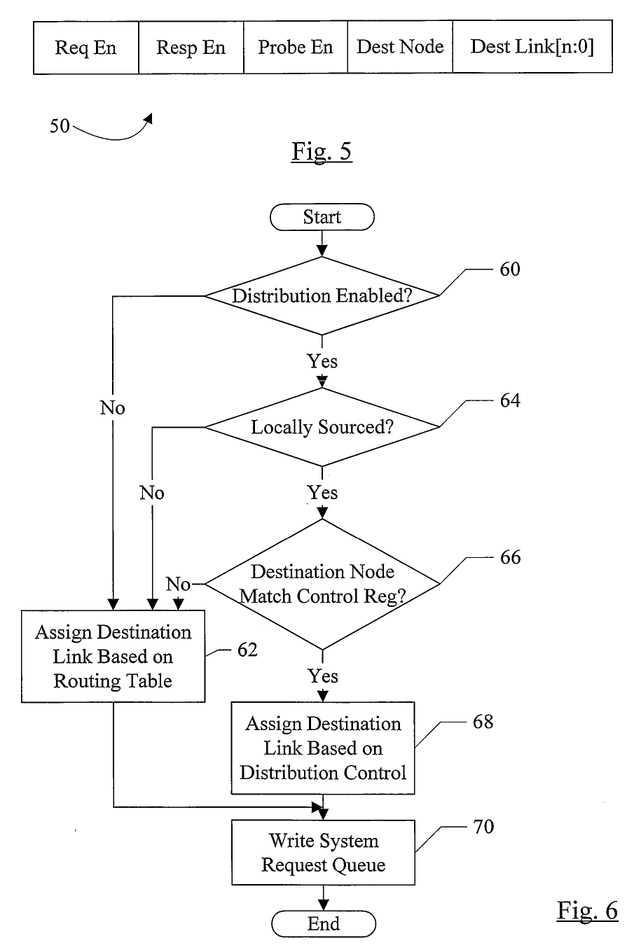

Turning now to FIG. 5, a block diagram of one embodiment of the distribution control register 50 is shown. In the illustrated embodiment, the control register 50 includes a request enable (Req En) field, a response enable (Resp En) field, a probe enable (Probe En) field, a destination node (Dest Node) field, and a destination link (Dest Link[n:0]) field.

The request, response, and probe enable fields permit enabling/disabling the packet distribution mechanism for different packet types. Other embodiments may include a single enable. Request packets include read and write requests to initiate transactions, as well as certain coherency-related requests (like change to dirty, to write a shared block that a node has cached). Response packets include responses to requests (e.g. read responses with data, probe responses, and responses indicating completion of a transaction). Probe packets are issued by the home node to maintain coherency, causing state change in caching nodes and optionally data movement as well, if a dirty copy exists (or might exist) and is to be forwarded to the requesting node or home node.

The destination node field identifies a destination node to which packets may be directed, and packets to that destination node are to be handled using the packet distribution mechanism. There may be multiple destination node fields to permit multiple destination nodes to be specified, or the destination node field may be encoded to specify more than one node.

A single destination node field that identifies a single node may be used for a two node system, for example. Each node may have the other node programmed into the destination node field of its distribution control register 50. Thus, packets directed to the other node may be distributed over the two or more links between the nodes. Packets not directed to the other node (e.g. packets to I/O nodes) may be routed to the interface circuit indicated by the routing table. In larger systems, the single node may identify another node to which two or more links are coupled, and other nodes may be routed via the routing table. Or, in larger systems, more destination node fields may be provided if there is more than one node to which multiple links are connected from the current node.

The destination link field may specify the two or more links (interface circuits) over which the packets are to be distributed. In one embodiment, the destination link field may by a bit vector, with one bit assigned to each link. If the bit is set, the link is included in the subset of links over which packets are distributed. If the bit is clear, the link in not included. Other embodiments may encode the links in different ways. In one particular embodiment, a link can be logically divided into sublinks (e.g. a 16 bit link could be divided into two independent 8 bit links). In such embodiments, distribution may be over the sublinks.

If more than one destination node is supported, than there may be more than one destination link field (e.g. there may be one destination link field for each supported destination node).

Turning next to FIG. 6, a flowchart is shown illustrating operation of one embodiment of the node controller 42 of FIG. 4 (and more particularly the distribution control unit 52 and/or the scheduler control unit 46, in one embodiment) to determine a destination link (interface circuit) on which a packet is to be transmitted. While the blocks are shown in a particular order for ease of understanding, other orders may be used. Blocks may be performed in parallel in combinatorial logic in the node controller 42. Blocks, combinations of blocks, and/or the flowchart as a whole may be pipelined over multiple clock cycles.

The node controller 42 may determine if distribution is enabled (decision block 60). The decision may be applied on a global basis (e.g. enabled or not enabled), or may be applied on a packet-type basis (e.g. the embodiment of FIG. 5, in which separate enables are provided for the request, response, and probe packet types). If distribution is not enabled (decision block 60, “no” leg), the node controller 42 may assign the destination link based on the routing table output (block 62) and may write the SRQ 44 with data representing the packet (block 70). The data representing the packet may include an indication of the assigned destination link, as well as other data such as a pointer to the buffer that is storing the packet, a pointer to a data buffer storing the data portion of the packet for those that contain data in addition to control, various other status data, etc. In other embodiments, the packets themselves may be written the to SRQ 44. If distribution is enabled (decision block 60, “yes” leg), and the packet is not locally sourced (decision block 64, “no” leg), the node controller 42 may also assign the destination link based on the routing table output (block 62) and write the SRQ 44 (block 70). If distribution is enabled (decision block 60, “yes” leg), and the packet is locally sourced (decision block 64, “yes” leg) but the destination node of the packet does not match the destination node or nodes programmed into the distribution control register 50 (decision block 66, “no” leg), the node controller 42 may again assign the destination link based on the routing table output (block 62) and write the SRQ 44 (block 70). Otherwise (decision blocks 60, 64, and 66, “yes” legs), the node controller 42 may assign the destination link based on the distribution control algorithm (block 68). The distribution control algorithm selects a link from the subset of links over which packet traffic is being distributed, dependent on the traffic that has been transmitted on the links. One embodiment is illustrated in FIG. 11 and described in more detail below. The node controller 42 may write the SRQ 44 (block 70).

In this embodiment, the distribution of packet traffic is performed at the time the SRQ 44 is written for a packet. Subsequent scheduling may be performed as normal. For example, each packet may be scheduled based on buffer availability at the receiver on the destination link assigned to that packet (for the coupon based scheme), along with any other scheduling constraints that may exist in various embodiments.

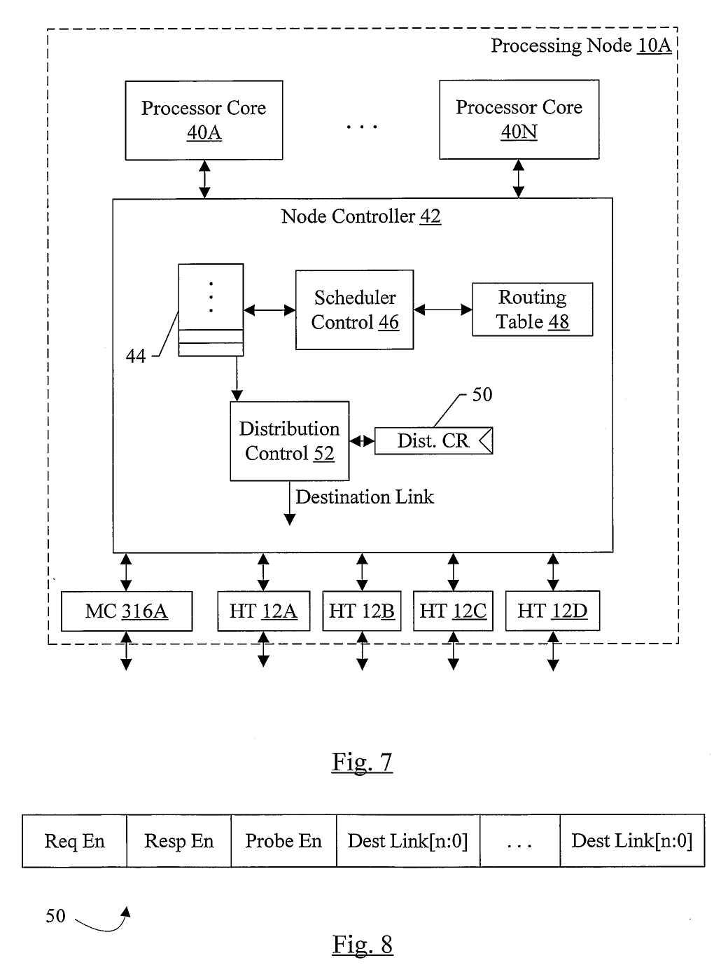

In another embodiment, packet distribution may be performed at the time the packet is scheduled for transmission (e.g. an embodiment is illustrated in FIG. 7) It is noted that packet distribution may be performed at any desired time in various embodiments.

In FIG. 7, the node 10A includes the processor cores 40A-40N, the node controller 42, the memory controller 316A, and the HT ports 12A-12D, similar to the embodiment of FIG. 4. Similar to the embodiment of FIG. 4, the processor cores 40A-40N, the memory controller 316A, and the HT ports 12A-12D may be coupled to the node controller 42. The node controller 42 includes the SRQ 44, the scheduler control unit 46, the routing table 48, the distribution control unit 52, and the distribution control register 50. The scheduler control unit 46 is coupled to the routing table 48 and the SRQ 44. The distribution control unit 52 is coupled to the SRQ 44 and the distribution control register 50, and is configured to output a destination link indication.

In this embodiment, the scheduler control unit 46 may determine an initial destination link for each packet (from any source, local or external, in this embodiment). The scheduler control unit 46 may write an indication of the initial destination link to the SRQ 44 along with other packet-related data. Scheduling may be performed based on this initial destination link as well (e.g. buffer readiness, based on the coupon scheme, etc.). In response to scheduling the packet, the packet data may be provided to the distribution control unit 52. The distribution control unit 52 may override the initial destination link, for some packets, based on the distribution control register 50 and the distribution control algorithm. The distribution control unit 52 may provide an indication of the destination link (either the new destination link or the initial destination link, if no new destination link is provided).

In this embodiment, packets from any source may be distributed. Additionally, in some embodiments, the distribution may be more accurate since the distribution occurs at packet scheduling time (as the packets are being provided to their destinations) and thus the traffic usage data may be more accurate.

Distribution may be affected by destination link, rather than destination node, in this embodiment. Other embodiments may still associate distribution with a defined destination node. An embodiment of the distribution control register 50 is shown in FIG. 8. The embodiment of FIG. 8 includes the request enable (Req En), response enable (Resp En), and probe enable (Probe En) fields, similar to the embodiment of FIG. 5. Additionally, the embodiment of FIG. 8 may include one or more destination link fields (Dest Link[n:0]). Each destination link field may specify two or more destination links over which traffic is being distributed. The initial destination link output by the routing table 48 may be represented in the destination link field, as well as one or more other links that are grouped with the initial link for packet distribution. If the initial destination link is represented in the destination link field, the initial link may be replaced by a new link selected from the field (although the new link may be the same as the initial link).

If distribution over two or more different subsets of links is to be supported, more than one destination link field may be included in the distribution control register 50, as illustrated in FIG. 8. That is, there may be one destination link field for each separate supported grouping of links for traffic distribution.

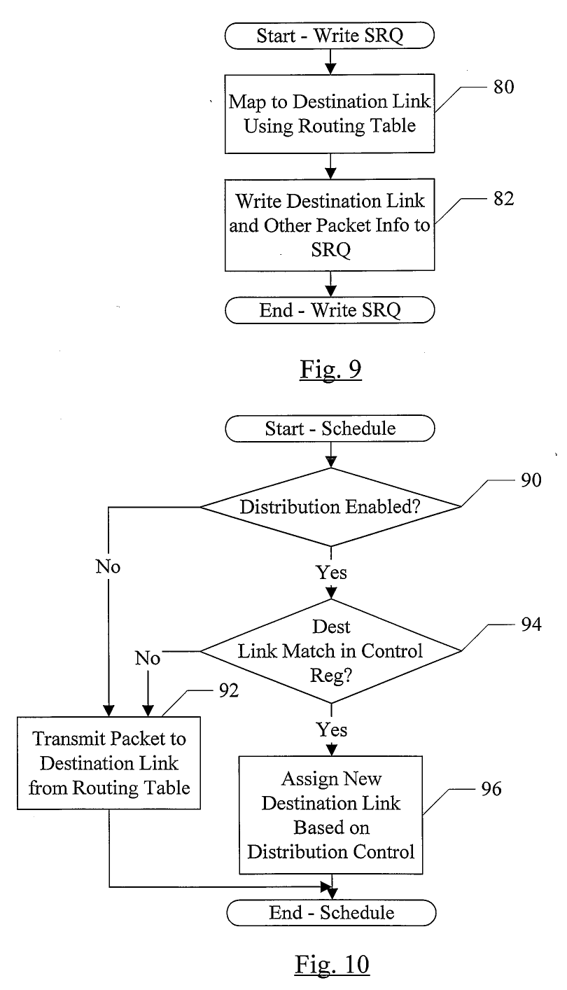

Turning next to FIG. 9, a flowchart is shown illustrating operation of one embodiment of the node controller 42 of FIG. 7 (and more particularly the scheduler control unit 46, in one embodiment) in response to receiving packet related data to write to the SRQ 44. While the blocks are shown in a particular order for ease of understanding, other orders may be used. Blocks may be performed in parallel in combinatorial logic in the node controller 42. Blocks, combinations of blocks, and/or the flowchart as a whole may be pipelined over multiple clock cycles.

The node controller 42 may map the packet to a destination link using the routing table 48 (block 80). The node controller 42 may write an indication of the destination link and other packet data to the SRQ 44 (block 82).

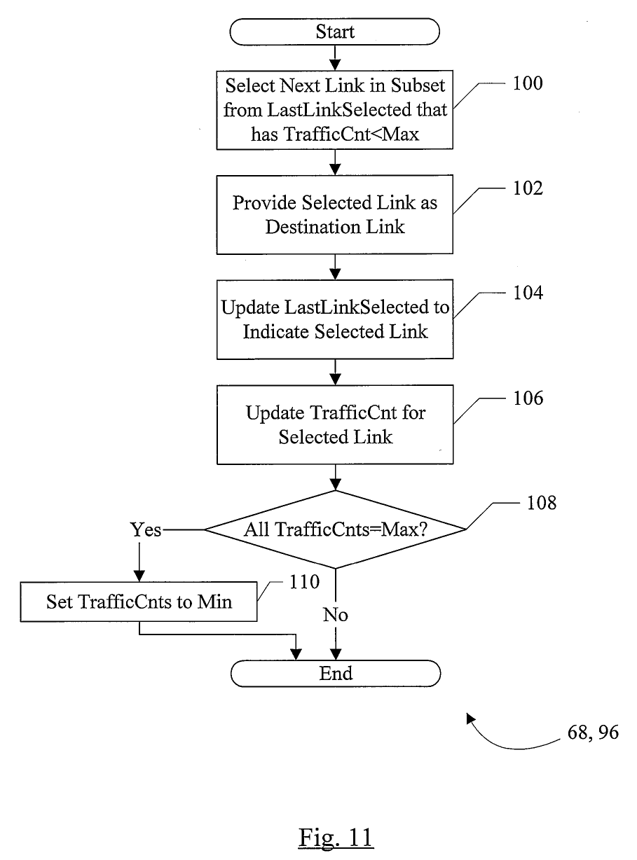

Turning next to FIG. 10, a flowchart is shown illustrating operation of one embodiment of the node controller 42 of FIG. 7 (and more particularly the distribution control unit 52, in one embodiment) in response to a packet being scheduled for transmission. While the blocks are shown in a particular order for ease of understanding, other orders may be used. Blocks may be performed in parallel in combinatorial logic in the node controller 42. Blocks, combinations of blocks, and/or the flowchart as a whole may be pipelined over multiple clock cycles.

If distribution is not enabled (decision block 90, “no” leg), the node controller 42 may cause the packet to be transmitted on the initial destination link based on the routing table output (block 92), as read from the SRQ 44. If distribution is enabled (decision block 90, “yes” leg), but the destination link of the packet (as read from the SRQ 44) does not match a destination link programmed into the distribution control register 50 (decision block 94, “no” leg), the node controller 42 cause the packet to be transmitted on the initial destination link (block 92) and write the SRQ 44 (block 70). Otherwise (decision blocks 90 and 94, “yes” legs), the node controller 42 may assign a new destination link based on the distribution control algorithm (block 96). The distribution control algorithm selects a link from the subset of links over which packet traffic is being distributed, dependent on the traffic that has been transmitted on the links in the subset. One embodiment is illustrated in FIG. 11 and described in more detail below.

Turning next to FIG. 11, a flowchart is shown illustrating operation of one embodiment of the node controller 42 of FIG. 7 (and more particularly the distribution control unit 52, in one embodiment) to determine a destination link dependent on the traffic on two or more links. That is, the flowchart of FIG. 11 may implement block 68 in FIG. 6 and/or block 96 in FIG. 10. While the blocks are shown in a particular order for ease of understanding, other orders may be used. Blocks may be performed in parallel in combinatorial logic in the node controller 42. Blocks, combinations of blocks, and/or the flowchart as a whole may be pipelined over multiple clock cycles.

Generally, the distribution control algorithm may include maintaining one or more traffic measurement values that indicate the relative amount of traffic on the links in the subset. The traffic measurement values may take on any form that directly measures or approximates the amount of traffic. For example, the traffic measurement values may comprise a value for each link, which may comprise a byte count or a packet count. If two links are used in the subset, a single traffic measurement value could be used that is increased for traffic on one link and decreased for traffic on another link.

For this embodiment, a traffic measurement value for each link may be maintained. The traffic measurement value may comprise an M bit counter that is initialized to zero and saturates at the maximum counter value. A packet without data (command only) may increment that counter by one. A packet with data may set the count to the max (since the data portion of the packet is substantially larger than the command portion, for block sized data, in this embodiment). For example, M may be 3, and the maximum amount may be seven.

In addition to the traffic measurement values, the node controller 42 may maintain a pointer identifying the most recently selected link (LastLinkSelected). The algorithm may include a round-robin selection among the links, excluding those that have traffic measurement values that have reached the maximum.

Thus, the node controller 42 may select the next link in the subset of links after the LastLinkSelected (rotating back to the beginning of the destination links field of the distribution control register) that has a corresponding traffic measurement value (TrafficCnt) less than the maximum value of the counter (Max) (block 100) and the selected link may be provided as the destination link, or new link (block 102). The node controller 42 may also update the LastLinkSelected pointer to indicate the selected link (block 104). The node controller 42 may update the TrafficCnt corresponding to the selected link (block 106). If all the TrafficCnts (corresponding to all the links in the subset) are at the Max (decision block 108, “yes” leg), the node controller 42 may set the TrafficCnts to the Min value (e.g. zero) (block 110).

Accordingly, the TrafficCnts represent the relative amount of traffic that has been recently transmitted on the links. Since a link having a TrafficCnt equal to Max is not selected, eventually each link will be selected enough times to reach Max. Accordingly, bandwidth should be relatively evenly consumed over the eligible links.

The above mentioned traffic measurement and selection algorithm is but one possible embodiment. For example, other embodiments may monitor traffic using similar traffic measurements, but may simply select the one indicating the least amount of traffic. Additionally, in cases in which an initial destination link is always determined the same from the routing table 48, the selection may favor other links in the subset (all else being equal) since the initial destination link's buffer availability is used as part of the scheduling decision, while the other links' buffer availability is not used.

It is noted that, in embodiments in which the destination link is selected via the packet distribution mechanism at packet scheduling time, the readiness of the eligible links may also be factored into the selection. That is, a link that cannot currently receive the packet may not be selected.

Numerous variations and modifications will become apparent to those skilled in the art once the above disclosure is fully appreciated. It is intended that the following claims be interpreted to embrace all such variations and modifications.

What is claimed is:

1. A node comprising:
a plurality of interface circuits, wherein each of the plurality of interface circuits is configured to couple to a respective link of a plurality of links; and
a node controller coupled to the plurality of interface circuits, wherein the node controller is configured to select a first link from two or more of the plurality of links to transmit a first packet, wherein the first link is selected responsive to a relative amount of traffic transmitted via each of the two or more of the plurality of links.

2. The node as recited in claim 1 wherein the node controller is programmable to identify the two or more of the plurality of links from which the first link is selected.

3. The node as recited in claim 2 wherein the node controller is configured to identify the two or more of the plurality of links dependent on a destination node of the first packet.

4. The node as recited in claim 2 wherein the node controller is configured to identify the two or more of the plurality of links dependent on an initial destination link assigned to the first packet.

5. The node as recited in claim 4 wherein the node controller comprises a routing table configured to identify the initial destination link dependent on one or more packet attributes of the first packet.

6. The node as recited in claim 5 wherein the node controller is configured to select a second link of the two or more of the plurality of links for a second packet having the same initial destination link, wherein the second link differs from the first link.

7. The node as recited in claim 1 wherein the node controller is configured to select a second link of the two or more of the plurality of links for a second packet having the same destination node, wherein the second link differs from the first link.

8. The node as recited in claim 1 wherein the node controller is configured to track the relative traffic on each of the two or more links using one or more traffic measurement values, and wherein the node controller is configured to update the one or more traffic measurement values to reflect transmission of the first packet via the first link.

9. A system comprising:
a first node configured to couple to a first plurality of links; and
a second node configured to couple to a second plurality of links, wherein at least two links of the second plurality of links are also included in the first plurality of links and link the first node to the second node, and wherein the second node is configured to transmit a plurality of packets to the first node, and wherein the second node is configured to distribute the plurality of packets over the at least two links responsive to a relative amount of traffic transmitted via each of the at least two links.

10. A method comprising:
receiving a first packet in a node controller within a node that is configured to couple to a plurality of links; and
selecting a link from two or more of the plurality of links to transmit the first packet, wherein the selecting is responsive to a relative amount of traffic transmitted via each of the two or more of the plurality of links.

11. The method as recited in claim 10 further comprising identifying the two or more of the plurality of links dependent on a destination node of the first packet.

12. The method as recited in claim 10 further comprising identifying the two or more of the plurality of links dependent on a destination link assigned to the first packet.

13. The method as recited in claim 12 further comprising identifying the destination link dependent on one or more packet attributes of the first packet.

14. The method as recited in claim 13 further comprising selecting a second link of the two or more of the plurality of links for a second packet having the same destination link, wherein the second link differs from the first link.

15. The method as recited in claim 10 further comprising selecting a second link of the two or more of the plurality of links for a second packet having the same destination node, wherein the second link differs from the first link.

16. A node comprising:
a plurality of interface circuits, wherein each of the plurality of interface circuits is configured to couple to a respective link of a plurality of links; and
a node controller coupled to the plurality of interface circuits, wherein the node controller comprises a routing table programmed to select among the plurality of links to transmit each packet of a plurality of packets, wherein the routing table is programmed to select among the plurality of links responsive to one or more packet attributes of each packet, and wherein the node controller is further configured to select a first link from two or more of the plurality of links for at least a first packet of the plurality of packets, and wherein the node controller is configured to transmit the first packet using the first link instead of a second link indicated by the routing table for the first packet.

17. The node as recited in claim 16 wherein the node controller is further configured, responsive to a second packet having a same one or more packet attributes as the first packet, to select a different link of the two or more of the plurality of links to transmit the second packet.

18. The node as recited in claim 16 wherein the node controller is configured to identify the two or more of the plurality of links dependent on a destination node of the first packet.

19. The node as recited in claim 16 wherein the node controller is configured to identify the two or more of the plurality of links dependent on the second link assigned to the first packet by the routing table.

20. The node as recited in claim 16 wherein the second link is one of the two or more links.
